(19) United States
(12) Patent Application Publication
(10) Pub. No.: US 2005/0017982 A1
(43) Pub. Date: Jan. 27, 2005

(54) Dynamic imposter generation with MIP map anti-aliasing

(76) Inventor: Francis James Kane JR., Winter Springs, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/625,315

(22) Filed: Jul. 23, 2003

(51) Int. Cl. G09G 5/00; G06T 17/00

(52) U.S. Cl. 345/582

(57) ABSTRACT

A method of providing an anti-aliased representation of an object, such as an imposter, in a computer graphic system. The method includes rendering a 3D computer graphic object to a 2D texture map and associating a set of 2D texture maps, such as MIP maps, with the 2D textured map. The method further includes blending at least two members of set of 2D texture maps to provide an anti-aliased representation of the object. The method may also include first rendering the 3D computer graphic object to the 2D texture map using a blending equation including color and alpha information, then re-rendering the rendered object using only corrected alpha values.

### BACKGROUND OF THE INVENTION

1. Field of the Invention

The present invention is generally related to computer graphics, and, specifically, to dynamically generating and rendering imposters with blended MIP maps.

2. Related Art

Typical computer graphics systems, for example, as used in the simulation and training field, dynamically display graphical representations of three dimensional objects (3D) on a two dimensional (2D) video display. These computer graphic systems can provide highly detailed representations in a simulation environment, at the cost of intensive processing demands needed to update graphic scenes and objects at update rates unnoticeable to a human observer.

One method of reducing processing demands in computer graphics systems is to represent 3D models as 2D images in a technique known as “impostering.” Impostering includes creating a “snapshot” of a 3D object as viewed from a predetermined angle. This snapshot is mapped as a texture to a transparent polygon, creating an “imposter” of the 3D model at the predetermined viewing angle. The imposter is used in the scene in place of the 3D model and may be updated as the viewing angle of the imposter is changed, so that a new imposter is created as the viewing position changes from frame to frame.

Imposters may also include an alpha channel that defines the imposter's opacity in some manner, for example, if the imposter includes a transparent element, such as a window. The opacity information stored in the alpha channel may vary fractionally from 0 (transparent) to 1 (opaque). Opacity information stored in the alpha channel may be used to blend foreground and background colors to achieve translucency. However, one problem with obtaining translucency in imposters is that the alpha channel is squared in the conventional process for converting the 3D model into a 2D imposter, resulting in incorrectly rendered translucency.

Another processing demand on computer graphic display systems is minimizing “aliasing.” Aliasing in a computer graphics system may be caused by the resolution limits of the display, wherein straight lines appear to have jagged edges. For example, aliasing may make it difficult for a human observer to detect, recognize, and identify models in a graphically rendered scene. Anti-aliasing techniques can alleviate aliasing, but at the cost of computationally intensive filtering processes.

Yet another processing demand is the use of scaled versions of textures to be applied to objects, or multum in parvo (MIP) maps, to achieve realistic effects as textured objects move closer or father away in a scene by displaying coarser resolutions of textures a farther distances away from the viewer. While MIP maps provide improved realism as objects move through a scene, blending of edges of MIP mapped textures, using known techniques such as bi-linear or tri-linear filtering, is required.

### SUMMARY OF THE INVENTION

A method of providing an anti-aliased representation of an object in a computer graphics system is described herein as including rendering a 3D computer graphic object to a 2D texture map. The method also includes creating a set of sequentially varying scaled resolution versions of the 2D texture map, and blending at least two sequentially adjacent versions to provide an anti-aliased representation of the object. The method may also include internally rendering, in a first pass, the 3D computer graphic object to a 2D texture map using color values and alpha values corresponding to the 3D computer graphic object, and the color values corresponding to the 2D texture map. The method may further include internally re-rendering the 3D computer graphic object to a 2D texture map to overwrite alpha values rendered in the first pass with corrected alpha values.

### BRIEF DESCRIPTION OF THE DRAWINGS

The features and advantages of the present invention will become apparent from the following detailed description of the invention when read with the accompanying drawings in which:

FIG. 1 illustrates an exemplary block diagram representation of a graphics rendering system.

FIG. 2 illustrates an exemplary representation of blending 3D model properties with texture map properties.

FIG. 3 is a flow chart illustrating a method of creating an anti-aliased imposter.

FIG. 4 is a flow chart illustrating in more detail the step of internally rendering 3D objects to 2D textures as shown in the flow chart of FIG. 3.

In certain situations, for reasons of computational efficiency or ease of maintenance, the ordering of the blocks of the illustrated flow charts of the relationships of blocks in the block diagrams could be rearranged by one skilled in the art. While the present invention will be described with reference to the details of the embodiments of the invention shown in the drawing, these details are not intended to limit the scope of the invention.

### DETAILED DESCRIPTION OF THE INVENTION

FIG. 1 illustrates an exemplary block diagram representation of a graphics rendering system 10. The system may include a host computer 12 operating over a host interface 14 to control a geometry accelerator 16. The geometry accelerator 16 operates in conjunction with a texture mapper 18 to provide input to the rasterizer 20 to generate pixel data stored in the frame buffer 22 for controlling the individual pixels of the display 24.

The host interface 14 communicates with the host computer 12 and receives “primitives” representative of images from the host computer to be displayed on the display 24. For example, the host interface 14 may be a computer bus interface such as a PCI interface, or a network interface such as an Ethernet interface. The primitives, such as points, lines, vectors and polygons, can be specified by X,Y,Z space coordinates, R,G,B color coordinates, and S, T, R, Q texture coordinates. The geometry accelerator 16 transforms the primitive coordinates received from the host interface 14 into screen space coordinates, and passes the transformed coordinates to the rasterizer 20. The rasterizer 20 then interpolates between transformed coordinates to provide image blending, and performs compositing of 3D images in 2D screen space. The rasterizer 20 also receives texture data from the texture mapper 18. For each pixel, the texture mapper 18 may have one or more texture MIP maps associated with the pixel and calculates resultant texture data for each pixel provided to the rasterizer 20. The frame buffer 22 receives information from the rasterizer 20 and may include a memory for storing the received information until the information is ready to be displayed as an image on the display 24.

The host interface 14, the geometry accelerator 16, the texture mapper 18, the rasterizer 20, and the frame buffer 22 may be included in a stand-alone image generator or on a dedicated graphics accelerator adapter installed in a personal computer (PC). Advantageously, the graphics accelerator adapter, such as the GeForce 4™ graphics accelerator adapter marketed by NVIDIA™ Corporation, may be capable of performing many of the desired functions in dedicated onboard hardware for increased processing speed. However, it should be understood that the techniques disclosed herein are not limited to use with a graphics accelerator card, but can be used on any type of computer graphics system capable of performing the techniques.

While processing speeds have increased and advanced computer graphics cards have allowed more realistic computer graphic simulations, methods of reducing processing loads in a computer graphics rendering pipeline are still needed. Imposters help reduce processing requirements, but imposters still need to be re-rendered as the viewing environment changes. In addition, imposters may suffer from aliasing effects. Consequently, the inventors have innovatively realized that by rendering a 3D model as a 2D imposter and using scaled resolution versions of the 2D imposter, the need to re-render imposters, for example, as a viewing distance changes, can be reduced, resulting in less processing overhead. Furthermore, by filtering the scaled resolution versions of the 2D imposter and blending scaled resolutions corresponding to a viewing distance from an observer, aliasing of the 2D imposter can be reduced without significantly increasing processing overhead.

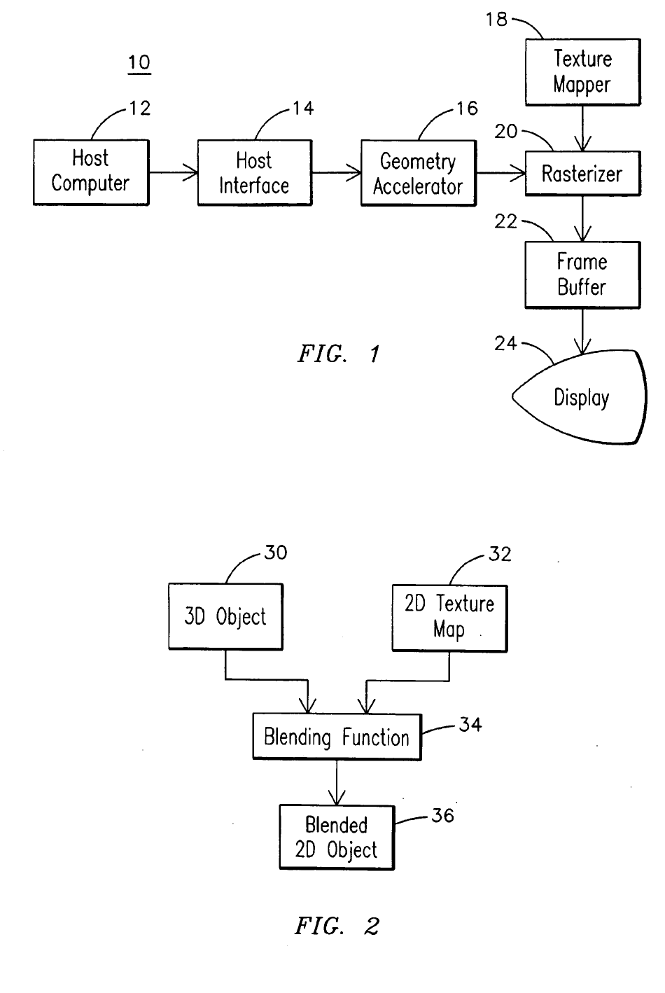

FIG. 2 illustrates an exemplary representation of blending 3D model properties with texture map properties. In general, blending takes a source object, such as a 3D object 30, having associated source color and alpha information for each pixel, and a destination object, such as a 2D texture 32, having associated destination color information for each pixel of the 2D texture, or texel, and combines the source and destination objects according to a blending function 34 to generate a blended 2D object 36, such as an imposter. For example, the blending function may be given by the formula (1):
C=As*Cs+(1−As)*Cd; (1)
where C=represents the final color drawn to the blended 2D object, As represents the alpha value corresponding to the 3D object, Cs represents the color value corresponding to the 3D computer graphic object, and Cd represents the color value corresponding to the 2D texture map.

FIG. 3 is a flow chart illustrating a method 40 of creating an anti-aliased imposter, for example, by using MIP maps. Initially, the rendering pipeline of a computer graphic system, such as a graphics accelerator adapter installed in a PC, is configured to render 3D objects directly to 2D texture maps. In addition, the texture maps to which the 3D objects are rendered may be initialized to the color black, with an alpha value of zero (0), or transparent. The process begins by internally rendering a 3D object to the 2D texture 42, such as by creating an imposter of the 3D of the object. For example, the 3D computer graphic object may be rendered to the 2D texture map at a resolution greater than the resolution of the 3D computer graphic object would conventionally be displayed. In one form the 2D texture map is rendered at 256 by 256 resolution. After the 3D object is rendered, a set of variably scaled resolution versions of the 2D texture map, or MIP maps, of the rendered 3D object are created and associated with the rendered 3D object, or imposter. The MIP maps may then be blended corresponding to a desired viewing distance 46 to provide an anti-aliased imposter. This blending step may further comprise trilinear filtering, as understood in the art. After blending, the anti-aliased imposter can be rendered to a display device. For example, rendering the imposter to a display device may include applying the imposter as a texture to a polygon, such as a square polygon, and then rendering the polygon to the display device. In an aspect of the invention, this rendering process may be repeated on a frame by frame basis to create a new anti-aliased imposter, for example, as a viewing angle of the object changes, such as by more than a predetermined angle, or lighting on the object changes. Advantageously, if only the viewing distance of the object changes, for example, an aircraft moving directly away from an observer, then no re-rendering is required. Progressively lower resolution versions of the imposter can be substituted for the object as the object recedes from the viewer.

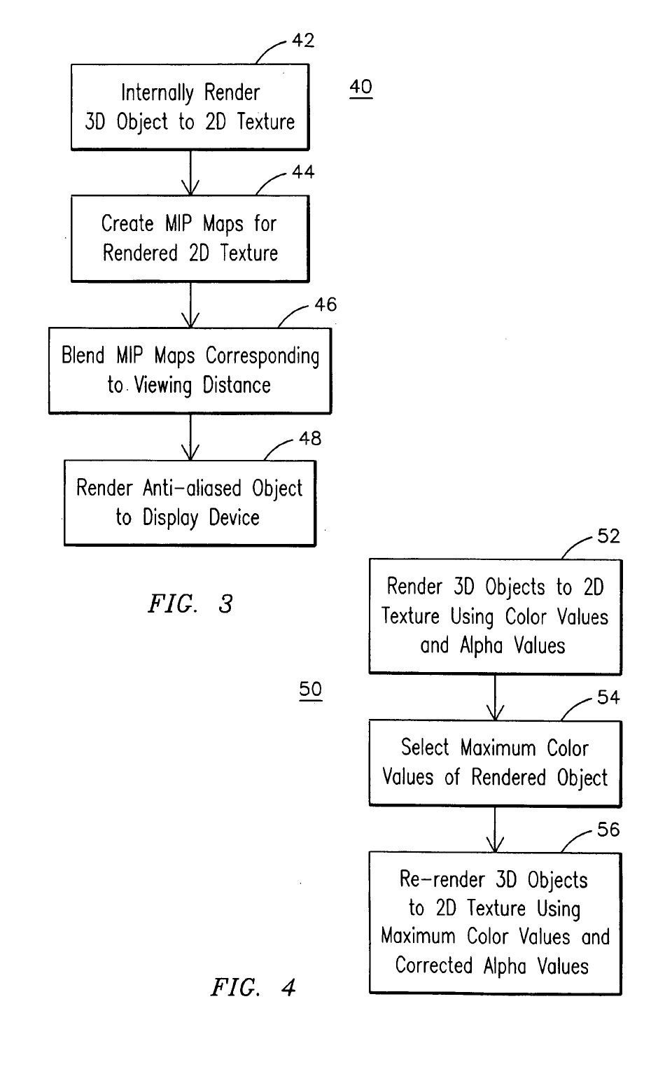

FIG. 4 is a flow chart illustrating in more detailed the step of internally rendering as shown in the flow chart of FIG. 3. In conventional impostering techniques, the alpha channel of the imposter is squared according to the blending formula (1), resulting in erroneous alpha values for the imposter, which may be manifested as incorrect translucency rendering, such as for aircraft or vehicle windshields. Accordingly, the steps in FIG. 4 illustrate a method 50 for correcting alpha value errors in an imposter by conventionally rendering the imposter in a first rendering pass, then re-rendering the imposter with corrected alpha values (such as the alpha values corresponding to the original 3D object) in a second pass. The method 50 begins by internally rendering, in the first pass, the 3D object to the 2D texture using the color values from both the 3D object and the 2D texture, and the alpha values from the 3D object 52, according to formula (1). Maximum color values are then selected from each texel of the rendered object 54 according to the formula (2):
C=MAX(CS, Cd); (2)
where C represents the maximum color value drawn to a respective texel in the texture map, Cs represents the color value of a respective pixel of the 3D computer graphic object, Cd represents the color value of the respective texel of the 2D texture map, and the function MAX determines the maximum of Cs and Cd. For example, to implement this function, the graphics accelerator adapter may be configured so that a computer graphics hardware blending equation is set to blend according to formula (2). After selecting the maximum color values, the object is internally re-rendered, in a second pass, using the maximum color values and corrected alpha values 54, such as the original alpha values associated with the 3D object. For example, a computer graphics hardware blending equation may be set to write only alpha values to the object for this step, without replacing the color values with the maximum values.

Accordingly, the correct alpha value can be restored so that translucent aspects of an object can be accurately represented in the image provided to the display device. Thus, an imposter of a 3D object can be rendered in a conventional blending manner, but advantageously incorporating an alpha channel preserving the original alpha information contained in the 3D object, instead of the squared alpha values obtained using conventional blending techniques. The resulting texture map representing the 3D object as a 2D imposter appears as it would appear if rendered as a 3D representation. Both the object and the background scene on which the object is composited will show properly through translucent portions of the object, such as aircraft cockpit canopies.

The present invention can be embodied in the form of computer-implemented processes and apparatus for practicing those processes. The present invention can also be embodied in the form of computer program code containing computer-readable instructions embodied in tangible media, such as floppy diskettes, CD-ROMs, hard disks, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose computer, the computer program code segments configure the computer to create specific logic circuits or processing modules.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

1. A method of providing a representation of an object in a computer graphics system:
rendering a 3D computer graphic object to a 2D texture map; and
creating a set of sequentially varying scaled resolution versions of the 2D texture map representative of the object at corresponding predetermined viewing distances.

2. The method of claim 1, further comprising blending at least two sequentially adjacent versions to provide an anti-aliased representation of the object at a corresponding predetermined viewing distances.

3. The method of claim 1, wherein an updated representation of the object is provided when a viewing angle of the object changes or lighting on the object changes.

4. The method of claim 1, wherein blending further comprises trilinear filtering.

5. The method of claim 1, further comprising rendering the 3D computer graphic object to a 2D texture map at a resolution greater than the resolution of the 3D computer graphic object.

6. The method of claim 1, further comprising rendering the 3D computer graphic object to a 2D texture map at a resolution of 256 by 256 texels.

7. The method of claim 1, further comprising:
applying at least one of the scaled resolution versions to a single polygon; and
rendering the polygon to a display device.

8. The method of claim 1, wherein the step of rendering further comprises:
internally rendering, in a first pass, the 3D computer graphic object to a 2D texture map using the color values and alpha values of the 3D computer graphic object, and the color values of the 2D texture map; and
internally re-rendering the 3D computer graphic object to a 2D texture map to overwrite the alpha values rendered in the first pass, with corrected alpha values.

9. The method of claim 8, further comprising assigning an alpha value of zero (0) to the 2D texture map.

10. The method of claim 8, further comprising:
selecting maximum color values rendered in the first pass; and
internally rendering, in a second pass, the 3D computer graphic object to a 2D texture map with the maximum color values.

11. The method of claim 10, wherein the maximum color value is selected according to the formula:
C=MAX(Cs, Cd);
where C represents the maximum color value drawn to each texel in the texture map, Cs represents the color value of the 3D computer graphic object, Cd represents the color value of the 2D texture map, and the function MAX determines the maximum of Cs and Cd.

12. The method of claim 8, wherein the step of internally rendering, in a first pass, is performed according to the formula:
C=As*Cs+(1−As)*Cd;
where C=represents the final color drawn to the 2D texture map, As represents the alpha value corresponding to the 3D object, Cs represents the color value of the 3D computer graphic object, and Cd represents the color value of the 2D texture map.

13. A method of anti-aliasing a computer graphics imposter comprising:
creating an imposter of an object;
creating MIP maps for the imposter; and
blending the MIP maps to provide an anti-aliased imposter.

14. A method of preserving translucency in a computer graphics imposter comprising:
internally rendering, in a first pass, a 3D computer graphic object to a 2D texture map using color values and alpha values corresponding to the 3D computer graphic object, and color values corresponding to the 2D texture map; and
internally re-rendering the 3D computer graphic object to a 2D texture map to overwrite alpha values rendered in the first pass with corrected alpha values.

15. A computer graphics generator apparatus comprising;
a rasterizer for rendering a 3D computer graphic object to a 2D texture map; and
a texture mapper for creating sequentially varying scaled resolution versions of the 2D texture map representative of the object at corresponding predetermined viewing distances.

16. A computer graphics system comprising:
a host computer;
the computer graphics generator apparatus card comprising a rasterizer for rendering a 3D computer graphic object to a 2D texture map, and a texture mapper for creating sequentially varying scaled resolution versions of the 2D texture map representative of the object at corresponding predetermined viewing distances; and
a host interface for coupling the computer graphics generator apparatus card to the host computer.
